(19) United States
(12) Patent Application Publication
(10) Pub. No.: US 2017/0275567 A1
(43) Pub. Date: Sep. 28, 2017

(54) DETERGENT COMPOSITION

(71) Applicant: BASF SE, Ludwigshafen (DE)

(72) Inventors: Christopher C. Caires, Birmingham, MI (US); Dustin Hawker, Royal Oak, MI (US); Keith E. Gutowski, Rochester Hills, MI (US); Catherine Breffa, Mannheim (DE); Claudia Esper, Kindenheim (DE); Alejandra Garcia Marcos, Ludwigshafen (DE); Rebecca L. Miller, Strongsville, OH (US); Oliver Spangenberg, Mannheim (DE)

(21) Appl. No.: 15/512,225

(22) PCT Filed: Jul. 29, 2015
(86) PCT No.: PCT/EP2015/067379

§ 371 Date: Mar. 17, 2017

Related U.S. Application Data
(60) Provisional application No. 62/052,508, filed on Sep. 19, 2014.
(60) Provisional application No. 62/116,592, filed on Feb. 16, 2015.

(51) Int. Cl. C11D 3/386; C11D 11/00; C11D 3/33

(52) U.S. Cl. CPC C11D 3/386; C11D 3/33; C11D 11/0023; C11D 11/0017

(57) ABSTRACT

The present invention is directed toward a detergent composition including (a) in total in the range of from 4.0% to 25.0% by weight of at least one organic chelating agent selected from methyl glycine diacetic acid (MGDA), glutamic acid diacetic acid (GLDA), the alkali metal salts of methyl glycine diacetic acid (MGDA) and glutamic acid diacetic acid (GLDA), referring to the total solids content of the respective detergent composition, and (b) at least one enzyme selected from proteases. The present invention is also directed toward the use of the detergent composition for laundry care and for automatic dishwashing, and to a process for manufacture of the detergent compositions.

The present invention is directed towards a detergent composition comprising
(a) in total in the range of from 4.0% to 25.0% by weight of at least one organic chelating agent selected from methyl glycine diacetic acid (MGDA), glutamic acid diacetic acid (GLDA), the alkali metal salts of methyl glycine diacetic acid (MGDA) and of glutamic acid diacetic acid (GLDA), referring to the total solids content of the respective detergent composition, and
(b) at least one enzyme selected from proteases.

Additionally, the present invention is directed towards the use of the inventive detergent composition for laundry care and for automatic dishwashing, and to a process for manufacture of the inventive detergent compositions.

Laundry detergent compositions have to fulfil numerous requirements. They are required to have excellent cleaning properties for various soiling of laundry including the removal of organic materials such as milk, blood, and egg residues. They are not only required to work with calcium- and magnesium-free water but also with hard water. They are required to be environmentally friendly; the use of phosphates as builder to remove water hardness is no longer accepted. Additionally, they are required to exhibit a certain shelf life.

Numerous organic chelating agents such as the alkali metal salts of MGDA and of GLDA have been developed as environmentally friendly chelating agents. They can replace most of the phosphate or even all of the phosphate in cleaning agents.

It can be observed, though, that many laundry detergents lose their efficacy concerning the removal of organic materials such as milk, blood, and especially of egg residues after some time of storage. Especially liquid laundry detergent compositions, exhibit only minor activity after a few weeks of storage at 30° C. or even higher temperatures, for example 35 or 37° C. Such temperatures are not only quite common in Southern European countries, Southern American countries and South-east Asia but also in laundering facilities.

Dishwashing compositions have to fulfil many requirements. Thus, they have to thoroughly clean the crockery, they should not put any harmful or potentially harmful substances into the waste water, they should allow the draining and drying of water from the crockery, and they should not cause any problems in the operation of the dishwasher. Finally, they should not cause any undesired esthetic effects on the item to be cleaned.

Without wishing to be bound to any theory it is believed that strong complexing agents may extract the central Ca²⁺ metal ion(s) of the active site(s) of detergent proteases and amylases, thus, reduce the activity of said enzymes.

It was therefore an objective of the present invention to provide a detergent composition that is environmentally friendly and also exhibits good performance with respect to the removal of organic materials such as milk, blood, and egg residues, even after a few weeks and more of storage at 30° C. or even higher temperatures, for example 35 or 37° C. Such detergent compositions can preferably be used in laundry or automatic dishwashing. It was also an objective to provide a process for manufacturing a detergent composition that is environmentally friendly and also exhibits good activity with respect to the removal of organic materials such as milk, blood, and egg residues. It was further an objective of the present invention to provide a method of use, and a use, of inventive detergent compositions.

Accordingly, the detergent compositions defined at the outset have been found. Such detergent compositions are hereinafter also being referred to as inventive detergent compositions and as detergent compositions according to the present invention.

Detergent composition according to the present invention comprises
(a) in total in the range of from 4.0% to 25.0% by weight of at least one organic chelating agent selected from methyl glycine diacetic acid (MGDA), glutamic acid diacetic acid (GLDA), the alkali metal salts of methyl glycine diacetic acid (MGDA) and of glutamic acid diacetic acid (GLDA), referring to the total solids content of the respective detergent composition, and
(b) at least one enzyme selected from proteases.

Inventive detergent compositions comprise
(a) in total in the range of from 4.0% to 25.0% by weight of at least one organic chelating agent selected from methyl glycine diacetic acid (MGDA), glutamic acid diacetic acid (GLDA), the alkali metal salts of methyl glycine diacetic acid (MGDA) and of glutamic acid diacetic acid (GLDA), referring to the total solids content of the respective detergent composition, in the context of the present invention also being referred to as chelating agent (a) or component (a).

Alkali metal salts may be selected from lithium salts, preferably potassium salts and even more preferably sodium salts.

In one embodiment of the present invention, alkali metal salts of MGDA are selected from those of general formula (I)

[CH₃—CH(COO)—N(CH₂—COO)₂]Na_{3-x-y}KₓH_{y} (I)
x being selected from 0.0 to 0.5, preferably up to 0.25,
y being selected from 0.0 to 0.5, preferably up to 0.25.

In one embodiment of the present invention, alkali metal salts of GLDA are selected from those of general formula (II)

[OOC—(CH₂)₂—CH(COO)—N(CH₂—COO)₂]Na_{4-x-y}KₓH_{y} (II)
x being selected from 0.0 to 0.5, preferably up to 0.25,
y being selected from 0.0 to 0.5, preferably up to 0.25.

Alkali metal salts of MGDA may be selected from alkali metal salts of the L-enantiomer, of the racemic mixture and of enantiomerically enriched alkali metal salts of MGDA, with an excess of L-enantiomer compared to the D-enantiomer. Preference is given to alkali metal salts of mixtures from the L-enantiomer and the D-enantiomer in which the molar ratio of L/D is in the range of from 55:45 to 85:15. Such mixtures exhibit a lower hygroscopicity than, e.g., the racemic mixture. The enantiomeric excess can be determined, e.g., by measuring the polarization (polarimetry) or preferably by chromatography, for example by HPLC with a chiral column, for example with one or more cyclodextrins as immobilized phase. Preferred is determination of the enantiomeric excess by HPLC with an immobilized optically active ammonium salt such as D-penicillamine.

Alkali metal salts of GLDA may be selected from alkali metal salts of the L-enantiomer, of the racemic mixture and of enantiomerically enriched GLDA, with an excess of L-enantiomer compared to the D-enantiomer. Preference is given to alkali metal salts of mixtures from L-enantiomer and D-enantiomer in which the molar ratio of L/D is in the range of from 80:20 or higher, preferably of from 85:15 up to 99:1. Such alkali metal salts of GLDA have a better bio-degradability than, e.g., the racemic mixture or the pure D-enantiomer. The enantiomeric excess can be determined, e.g., by measuring the polarization (polarimetry) or preferably by chromatography, for example by HPLC with a chiral column, for example with one or more cyclodextrins as immobilized phase. Preferred is determination of the enantiomeric excess by HPLC with an immobilized optically active ammonium salt such as D-penicillamine.

In any way, minor amounts of chelating agent (a) may bear a cation other than alkali metal. It is thus possible that minor amounts, such as 0.01 to 5 mol-% of total chelating agent (a) bear alkali earth metal cations such as Mg²⁺ or Ca²⁺, or a transition metal cation such as a Fe²⁺ or Fe³⁺ cation.

In one embodiment of the present invention, chelating agent (a) may contain one or more impurities that may result from the production of the respective chelating agent. In the case of MGDA and its alkali metal salts, such impurities may be selected from alkali metal propionate, lactic acid, alanine or the like. Such impurities are usually present in minor amounts. In the context of the present invention, such minor amounts are neglected when determining the composition of chelating agent (a). In the case of GLDA and its alkali metal salts, such impurities may be selected from alkali glutamine monoacetic acid trisodium salt, glycolate, and formate. “Minor amounts” in this context refer to a total of 0.1 to 1% by weight, referring to the respective chelating agent (a).

The contents of chelating agent (a) amounts to in total in the range of from 4.0% to 25.0% by weight, referring to the total solids content of the respective detergent composition. Such contents refer to the sum of chelating agent(s) (a).

In a preferred embodiment, the inventive detergent composition comprises in total in the range of from 4.0% to 20.0% by weight, preferably in the range of from 5.0% to 18.0%, more preferably in the range of from 5.0% to 15.0%, most preferably in the range of from 5.9 to 15.0% by weight, of at least one organic chelating agent selected from methyl glycine diacetic acid (MGDA), glutamic acid diacetic acid (GLDA), the alkali metal salts of methyl glycine diacetic acid (MGDA) and of glutamic acid diacetic acid (GLDA), referring to the total solids content of the respective detergent composition.

Detergent compositions according to the present invention also comprise at least 0.2% by weight of at least one enzyme selected from proteases, in the context of the present invention also being referred to as enzyme (b or protease (b), referring to the total solids content of the respective detergent composition. In the context of the present invention, the terms protease and peptidase may be used interchangeably. In a preferred embodiment, the detergent composition comprises in total in the range of from 0.2% to 3.0, preferably up to 2.0% by weight of at least one enzyme selected from proteases, referring to the total solids content of the respective detergent composition.

In a particularly preferred embodiment, the detergent composition comprises
(a) in total in the range of from 5.9 to 15.0% by weight of at least one organic chelating agent selected from methyl glycine diacetic acid (MGDA), glutamic acid diacetic acid (GLDA), the alkali metal salts of methyl glycine diacetic acid (MGDA) and of glutamic acid diacetic acid (GLDA), referring to the total solids content of the respective detergent composition, and
(b) in total in the range of from 0.2 to 3.0, preferably up to 2.0% by weight of at least one enzyme selected from proteases, referring to the total solids content of the respective detergent composition.

Proteases are enzymes that perform proteolysis, i.e. that hydrolyse the peptide bonds that link amino acids together in the polypeptide chain forming the protein. Methods for determining protease activity are known in the art.

Preferably, proteases (b) in the context of the present invention are serine proteases such as, but not limited to, chymotrypsin EC 3.4.21.1 (valid as of Sep. 9, 2014), elastase EC 3.4.21.36 (valid as of Sep. 9, 2014), elastase EC 3.4.21.37(valid as of Sep. 9, 2014), elastase EC 3.4.21.71 (valid as of Sep. 9, 2014), granzyme EC 3.4.21.78 (valid as of Sep. 9, 2014), granzyme EC 3.4.21.79 (valid as of Sep. 9, 2014), kallikrein EC 3.4.21.34 (valid as of Sep. 9, 2014), kallikrein EC 3.4.21.35 (valid as of Sep. 9, 2014), kallikrein EC 3.4.21.118 (valid as of Sep. 9, 2014), kallikrein EC 3.4.21.119 (valid as of Sep. 9, 2014), plasmin EC 3.4.21.7 (valid as of Sep. 9, 2014), trypsin EC 3.4.21.4 (valid as of Sep. 9, 2014), thrombin EC 3.4.21.5 (valid as of Sep. 9, 2014) and preferably subtilisin (also known as subtilipeptidase) EC 3.4.21.62 (valid as of Sep. 9, 2014), hereinafter also being referred to as subtilisin (b).

By “serine protease” in connection with this invention is meant an enzyme classified as EC 3.4.21 (valid as of Sep. 9, 2014) by the Nomenclature of the International Union of Biochemistry and Molecular Biology. Proteases can be classified using group specific inhibitors. The diverse group of serine protease inhibitors includes synthetic chemical inhibitors and natural proteinaceous inhibitors. Thus, the serine protease activity can be determined in an assay based on cleavage of a specific substrate or in an assay using any protein containing substrate with or without a specific inhibitor of serine proteases under suitable conditions.

By the term “serine protease activity” as used in accordance with the present invention is meant hydrolytic activity on protein containing substrates, e.g. casein, haemoglobin and BSA. The methods for analyzing proteolytic activity are well-known in the literature and are described e.g. in Gupta et al. (Appl. Microbiol. Biotechnol. 60: 381-395).

Subtilisin EC 3.4.21.62 (valid as of Sep. 9, 2014), a serine protease, acts as non-specific endopeptidase, i.e., it hydrolyzes any acid amide bonds located inside peptides or proteins. Its optimum pH is usually in the neutral to distinctly alkaline range.

Proteases of the subtilisin type (subtilases, subtilopeptidases, EC 3.4.21.62, valid as of Sep. 9, 2014) are classed as belonging to the serine proteases, due to the catalytically active amino acids. They are naturally produced and secreted by microorganisms, in particular by Bacillus species. They act as unspecific endopeptidases, i.e. they hydrolyze any acid amide bonds located inside peptides or proteins. Their pH optimum is usually within the neutral to distinctly alkaline range. A review of this family is provided, for example, in the paper “Subtilases: Subtilisin-like Proteases” by R. Siezen, pages 75-95 in “Subtilisin enzymes”, edited by R. Bott and C. Betzel, New York, 1996. Subtilisins are suitable for a multiplicity of possible technical uses, in particular as active ingredients of detergents or cleaning agents.

The class of serine proteases shares a common amino acid sequence defining a catalytic triad which distinguishes them from the chymotrypsin related class of serine proteases. Subtilisins and chymotrypsin related serine proteases both have a catalytic triad comprising aspartate, histidine and serine. In the subtilisin related proteases the relative order of these amino acids, reading from the amino to carboxy terminus is aspartatehistidine-serine. In the chymotrypsin related proteases the relative order, however is histidine-aspartateserine. Thus, subtilisin herein refers to a serine protease having the catalytic triad of subtilisin related proteases. Examples include the subtilisins identified in FIG. 3 herein and as described in WO 89/06276 and EP 0 283 075, WO 89/06279, WO 89/09830, WO 89/09819 and W09106637.

The main representatives are the subtilisins from Bacillus amyloliquefaciens (called BPN') and Bacillus licheniformis (called subtilisin Carlsberg), the serine protease PB92, subtilisin 147 and/or 309 (sold under the trade name Savinase® by Novozymes A/S, Bagsvaerd , Denmark) and subtilisin from Bacillus lentus, especially from Bacillus lentus (DSM 5483, named BLAP) and each of the variants available via mutagenesis of these enzymes.

In a preferred embodiment the subtilisin is a wild-type enzyme or a subtilisin variant, in which the wild-type enzyme or the starting enzyme variant is selected from the following:

subtilisin from Bacillus amyloliquefaciens BPN',

subtilisin from Bacillus licheniformis (subtilisin Carlsberg),

subtilisin PB92,

subtilisin 147 and/or 309 (Savinase®),

subtilisin from Bacillus lentus, preferably from Bacillus lentus DSM 5483 or the variant of Bacillus lentus DSM 5483 as described in WO 95/23221,

subtilisin from Bacillus alcalophilus (DSM 11233) disclosed in DE 10064983,

subtilisin from Bacillus gibsonii (DSM 14391),

subtilisin from Bacillus sp. (DSM 14390) disclosed in WO 03/056017,

subtilisin from Bacillus sp. (DSM 14392) disclosed in WO 03/055974,

subtilisin from Bacillus gibsonii (DSM 14393) disclosed in WO 03/054184,

subtilisin having SEQ ID NO. 4 as described in WO 2005/063974 A1 or a subtilisin which is at least 40% identical thereto and having serine protease activity,

subtilisin having SEQ ID NO. 4 as described in WO 2005/103244 A1 or subtilisin which is at least 80% identical thereto and having serine protease activity,

subtilisin having SEQ ID NO. 7 as described in WO 2005/103244 A1 or subtilisin which is at least 80% identical thereto and having serine protease activity, and

subtilisin having SEQ ID NO. 2 as described in application DE 102005028295.4 or subtilisin which is this at least 66% identical thereto and having serine protease activity.

In a more preferred embodiment, the subtilisin (b) is selected from the group consisting of subtilisin BPN′ from Bacillus amyloliquefaciens, the subtilisin having SEQ ID NO. 1 as described in WO 2011/032988 and subtilisin which is at least 80% identical to SEQ ID NO. 1 as described in WO 2011/032988 and having serine protease activity.

In an even more preferred embodiment, the subtilisin (b) is selected from the group consisting of mutant subtilisin protease as described in EP 0 701 605 A1, characterized by at least one amino acid alteration which results in a reduced positive charge or an increased negative charge in the region of the substrate binding pocket, wherein said amino acid alteration is L211D according to the counting of SEQ ID NO. 22, preferably the mutant subtilisin protease derived from the protease described by SEQ ID NO. 24 by the following amino acid alteration: L211D, preferably a protease described by SEQ ID NO. 16, SEQ ID NO. 17 or SEQ ID NO. 18, more preferably the mutant subtilisin protease derived from the protease described by SEQ ID NO 23 by one of the following additional amino acid alterations: R99G, R99A or R99S as described in EP 0 701 605 A1.

The wild-type enzymes described below can be purchased from commercial suppliers or isolated from the indicated microorganisms obtainable from state or state-approved depositories such as the DSMZ (German Collection of Microorganisms and Cell Cultures GmbH, Mascher Weg 1b, 38124 Braunschweig) or the ATCC (American Type Culture Collection, 10801 University Boulevard, Manassas, Va. 20110-2209, USA).

Alternatively, it is possible to use the corresponding sequence information from the specified documents, or to use databases such as GenBank (National Center for Biotechnology Information NCBI, National Institutes of Health, Bethesda, Md., USA).

With this information, it is possible to produce the enzymes by applying established molecular biological steps. Methods for producing variants with mutations in one or more positions are known in the art.

All of the wild-type enzymes or variants known in the art can be added to the inventive detergent composition.

Subtilisin BPN′, which originates from Bacillus amyloliquefaciens, respectively Bacillus subtilis, has been described by Vasantha et al. (1984) J. Bacteriol. Volume 159, p. 811-819 and J A Wells et al. (1983) in Nucleic Acids Research, Volume 11, p. 7911-7925.

The subtilisin Carlsberg is disclosed in E L Smith et al. (1968) in J. Biol Chem, Volume 243, pp. 2184-2191, and Jacobs et al. (1985) in Nucl. Acids Res, Vol 13, p. 8913-8926. It is naturally produced by Bacillus licheniformis, and is availabe under the trade name Maxatase® from Genencor International Inc., Rochester, N.Y., USA, and under the trade name Alcalase® from Novozymes A/S, Bagsvaerd, Denmark.

The subtilisin PB92 is naturally produced by the alkaliphilic bacterium Bacillus nov. spec. 92 and can be obtained from Gist-Brocades, Delft, The Netherlands, under the trade name Maxacal®. The original sequence of the alkaline protease PB92 is described in EP 283075 A2.

The subtilisins 147 and 309 are obtainable under the trade names Esperase®, respectively Savinase® by Novozymes.

The subtilisin from B. lentus has been described in WO 91/02792 A1. It has a comparatively high stability against oxidation and the action of detergents. In WO 91/02792 A1, or EP 493398 B1 and U.S. Pat. No. 5,352,604, the heterologous expression of this subtilisin in B. licheniformis ATCC 53926 has been described.

The protease from Bacillus lentus DSM 5483 is sold under the name BLAP®. Further preferred proteases include enzymes sold under the trade name PUR. Other proteases are also sold under the trade name Durazym®, Relase®, Everlase®, Nafizym®, Natalase®, Kannase® and Ovozyme® from Novozymes, under the trade names Purafect® (Effectenz® P), Purafect® OxP Purafect® Prime (Preferenz® P), Excellase® (Excellenz® P) and Properase® from Genencor.

The variants shown to be beneficial in the claimed applications are accordingly preferred in the context of the present invention.

The variants of subtilisin described above can have an amino acid sequence which is at least n % identical to the amino acid sequences described above having serine protease activity with n being an integer between 10 and 100, preferably 10, 15, 20, 25, 30, 35, 40, 45, 50, 55, 60, 65, 70, 75, 80, 85, 90, 91, 92, 93, 94, 95, 96, 97, 98 or 99.

Preferably, the degree of identity is determined by comparing the respective sequence with the amino acid sequence of any one of the above-mentioned subtilisin amino acid sequences. When the sequences which are compared do not have the same length, the degree of identity preferably either refers to the percentage of amino acid residues in the shorter sequence which are identical to amino acid residues in the longer sequence or to the percentage of amino acid residues in the longer sequence which are identical to amino acid residues in the shorter sequence. The degree of sequence identity can be determined according to methods well known in the art using preferably suitable computer algorithms such as CLUSTAL. When using the Clustal analysis method to determine whether a particular sequence is, for instance, 80% identical to a reference sequence default settings may be used or the settings are preferably as follows: Matrix: blosum 30; Open gap penalty: 10.0; Extend gap penalty: 0.05; Delay divergent: 40; Gap separation distance: 8 for comparisons of amino acid sequences. Preferably, the degree of identity is calculated over the complete length of the sequence.

Detergent compositions according to the present invention further comprise at least one anionic surfactant (c), in the context of the present invention also being referred to as anionic surfactant(s) (c), surfactants (c) or component (c).

Examples of suitable anionic surfactants (c) are alkali metal and ammonium salts of C₈-C₁₈-alkyl sulfates, of C₈-C₁₈-fatty alcohol polyether sulfates, of sulfuric acid half-esters of ethoxylated C₄-C₁₂-alkylphenols (ethoxylation: 1 to 50 mol of ethylene oxide/mol), C₁₂-C₁₈ sulfo fatty acid alkyl esters, for example of C₁₂-C₁₈ sulfo fatty acid methyl esters, furthermore of C₁₂-C₁₈-alkylsulfonic acids and of C₁₀-C₁₈-alkylarylsulfonic acids. Preference is given to the alkali metal salts of the aforementioned compounds, particularly preferably the sodium salts.

More preferred anionic surfactants (c) are selected from C₈-C₂₀-alkyl sulfonates, C₈-C₂₀-alkyl sulfates and C₈-C₂₀-alkyl ether sulfonates, especially the respective sodium salts. Examples of particularly preferred anionic surfactants (c) are n-C₁₂H₂₅—O(CH₂CH₂O)₂—SO₃Na and n-C₁₂H₂₅—O(CH₂CH₂O)₃—SO₃Na.

Further examples for suitable anionic surfactants are soaps, for example the sodium or potassium salts of stearoic acid, oleic acid, palmitic acid, ether carboxylates, and alkylether phosphates.

Inventive detergent compositions further comprise at least non-ionic surfactant (d), hereinafter also being referred to as non-ionic surfactant(s) (d), surfactants (d) or component (d).

Preferred non-ionic surfactants (d) are alkoxylated alcohols, preferably branched C₁₀ alcohols alkoxylated, alkoxylated fatty alcohols, di- and multiblock copolymers of ethylene oxide and propylene oxide and reaction products of sorbitan with ethylene oxide or propylene oxide, alkyl polyglycosides (APG), hydroxyalkyl mixed ethers and amine oxides.

Preferred examples of alkoxylated alcohols and alkoxylated fatty alcohols are, for example, compounds of the general formula (I)

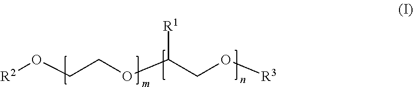

in which the variables are defined as follows:
R¹ is identical or different and selected from hydrogen and linear C₁-C₁₀-alkyl, preferably in each case identical and ethyl and particularly preferably hydrogen or methyl,
R² is selected from C₈-C₂₂-alkyl, branched or linear, for example n-C₈₁-C₁₇, n-C₁₀HC₂₁, n-C₁₂H₂₅, n-C₁₄H₂₉, n-C₁₆HC₃₃ or n-C₁₈H₃₇,
R³ is selected from C₁-C₁₀-alkyl, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl or isodecyl, m and n are in the range from zero to 300, where the sum of n and m is at least one, preferably in the range of from 3 to 50. Preferably, m is in the range from 1 to 100 and n is in the range from 0 to 30.

In one embodiment, compounds of the general formula (I) may be block copolymers or random copolymers, preference being given to block copolymers.

Other preferred examples of alkoxylated alcohols are, for example, compounds of the general formula (II)

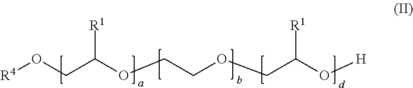

in which the variables are defined as follows:
R¹ is identical or different and selected from hydrogen and linear C₁-C₀-alkyl, preferably identical in each case and ethyl and particularly preferably hydrogen or methyl,
R⁴ is selected from C₆-C₂₀-alkyl, branched or linear, in particular n-C₈H₁₇, n-C₁₀H₂₁, n-C₁₂H₂₅, n-C₁₄H₂₉, n-C₁₆H₃₃, n-C₁₈H₃₇,
a is a number in the range from zero to 10, preferably from 1 to 6,
b is a number in the range from 1 to 80, preferably from 4 to 20,
d is a number in the range from zero to 50, preferably 4 to 25.

The sum a+b+d is preferably in the range of from 5 to 100, even more preferably in the range of from 9 to 50.

Preferred examples for hydroxyalkyl mixed ethers are compounds of the general formula (III)

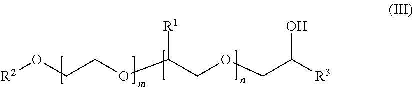

in which the variables are defined as follows:
R¹ is identical or different and selected from hydrogen and linear C₁-C₁₀-alkyl, preferably in each case identical and ethyl and particularly preferably hydrogen or methyl,
R² is selected from C₈-C₂₂-alkyl, branched or linear, for example iso-C₁₁H₂₃, iso-C₁₃H₂₇, n-C₈H₁₇, n-C₁₀H₂₁, n-C₁₂H₂₅, n-C₁₄H₂₉, n-C₁₆H₃₃ or n-C₁₈H₃₇,
R³ is selected from C₁-C₁₈-alkyl, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl, isodecyl, n-dodecyl, n-tetradecyl, n-hexadecyl, and n-octadecyl.

The integers m and n are in the range from zero to 300, where the sum of n and m is at least one, preferably in the range of from 5 to 50. Preferably, m is in the range from 1 to 100 and n is in the range from 0 to 30.

Compounds of the general formula (II) and (III) may be block copolymers or random copolymers, preference being given to block copolymers.

Further suitable nonionic surfactants (d) are selected from di- and multiblock copolymers, composed of ethylene oxide and propylene oxide. Further suitable nonionic surfactants are selected from ethoxylated or propoxylated sorbitan esters. Amine oxides or alkyl polyglycosides, especially linear C₄-C₁₆-alkyl polyglucosides and branched C₈-C₁₄-alkyl polyglycosides such as compounds or mixture of compounds of average general formula (IV) are likewise suitable.

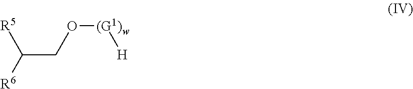

wherein the integers are defined as follows:
R⁵ is C₁-C₄-alkyl, in particular ethyl, n-propyl or isopropyl,
R⁶ is —(CH₂)₂—R⁵,
G¹ is selected from monosaccharides with 4 to 6 carbon atoms, especially from glucose and xylose,
w in the range of from 1.1 to 4, w being an average number,

An overview of suitable further nonionic surfactants can be found in EP-A 0 851 023 and in DE-A 198 19 187.

Mixtures of two or more different non-ionic surfactants (d) may also be present in the detergent composition according to the present invention.

In one embodiment of the present invention, the non-ionic surfactant (d) is selected from C₈-C₂₀-alkyl alkoxylates.

Enzyme (b) may be present in stabilized or non-stabilized form. Stabilization of enzyme (b) may be accomplished with borax or boronic acid derivatives such as 4′FPBA (Formylphenyboronic acid) (e.g. Savinase® Ultra, Liquinase® Ultra obtainable from Novozymes) or with sodium salts of formic or acetic acid or with the disodium salt of at least one α,ω-C₄-C₇-dicarboxylic acid. The stabilizing agents may be present in an amount of from 1 to 2.5% by weight.

In a preferred embodiment, inventive detergent compositions are free from phosphate. The terms “free from phosphate” and “phosphate-free” are being used interchangeable in the context of the present invention. In the context of the present invention, free from phosphate is to be understood, as meaning that the content of phosphate and polyphosphate is in sum in the range from 10 ppm to 0.2% by weight, determined by gravimetry and referring to the respective inventive detergent composition.

In one embodiment of the present invention, inventive detergent compositions comprise
(a) in total in the range of from 4.0% to 25.0% by weight of chelating agent (a),
(b) in total of 0.2% to 3.0, preferably up to 2.0% by weight of protease,
(c) in total in the range of from 2% to 50% by weight of anionic surfactant (c), preferably 10% to 30% by weight,
(d) in total of 1.6% to 20% by weight of non-ionic surfactant.

In a further embodiment of the present invention, inventive detergent compositions for automatic dish washing comprise
(a) in total in the range of from 4.0% to 25.0% by weight of chelating agent (a), preferably 5.9% to 15% by weight,
(b) in total of 0.2 to 3.0, preferably up to 2.0% by weight of protease,
(c) in total of 1.6 to 20% by weight of non-ionic surfactant, preferably a branched C10 alcohol alkoxylate.

In one embodiment of the present invention, inventive detergent compositions may have a pH value in the range of from 7.5 to 11.5, preferably 7.5 to 8.5 for liquid laundry, 8.5 to 9.5 for pow-der laundry and 9.0 to 11.5 for automatic dishwashing. The pH value is determined based on a 1% by weight aqueous solution or slurry of the respective inventive detergent.

Inventive detergent composition may further comprise at least one optional ingredient, for example one or more amphoteric surfactants.

Examples of amphoteric surfactants are those that bear a positive and a negative charge in the same molecule under use conditions. Preferred examples of amphoteric surfactants are so-called betaine-surfactants. Many examples of betaine-surfactants bear one quaternized nitrogen atom and one carboxylic acid group per molecule. A particularly preferred example of amphoteris surfactants that can be used in accordance with the present invention is cocamidopropyl betaine (lauramidopropyl betaine). Examples of amine oxide surfactants are compounds of the general formula (V)

R⁷R⁸R⁹N→O (V)

wherein R⁷, R⁹ and R⁹ are selected independently from each other from aliphatic, cycloaliphatic or C₂-C₄-alkylene C₁₀-C₂₀-alkylamido moieties. Preferably, R⁷ is selected from C₈-C₂₀-alkyl or C₂-C₄-alkylene C₁₀-C₂₀-alkylamido and R⁹ and R⁹ are both methyl.

A particularly preferred example is lauryl dimethyl aminoxide, sometimes also called lauramine oxide. A further particularly preferred example is cocamidylpropyl dimethylaminoxide, sometimes also called cocamidopropylamine oxide.

Further optional ingredients may be but are not limited to sodium carbonate, sodium sulfate, bleaching agents, bleach catalysts, bleach activators, viscosity modifiers, cationic surfactants, corrosion inhibitors, amphoteric surfactants, foam boosting or foam reducing agents, enzymes other than proteases (b), perfumes, dyes, optical brighteners, dye transfer inhibiting agents and preservatives.

Examples of enzymes other than protease (b) are cellulases, lipases, esterases, pectinases, and preferably amylases.

Detergent compositions according to the invention may comprise one or more bleaching agents (bleaches). Preferred bleaching agents are selected from peroxy compounds.

Examples of suitable peroxy compounds are sodium persulfate, wherein the term “persulfate” in each case includes the salt of the peracid H₂SO₅ and also the peroxodisulfate, sodium perbo-rate, anhydrous or for example as monohydrate or as tetrahydrate or so-called dihydrate, sodium percarbonate, anhydrous or, for example, as monohydrate, hydrogen peroxide, persulfates, organic peracids such as peroxylauric acid, peroxystearic acid, peroxy-α-naphthoic acid, 1,12-diperoxydodecanedioic acid, perbenzoic acid, peroxylauric acid, 1,9-diperoxyazelaic acid, diperoxyisophthalic acid, in each case as free acid or as alkali metal salt, in particular as sodium salt, also sulfonylperoxy acids and cationic peroxy acids.

In a preferred embodiment, the peroxy compound is selected from inorganic percarbonates, persulfates and perborates. Examples of sodium percarbonates are 2 Na₂CO₃.3 H₂O₂. Examples of sodium perborate are (Na₂[B(OH)₂(O₂)]₂), sometimes written as NaBO₂.O₂.3H₂O instead. Most preferred peroxy compound is sodium percarbonate.

In this connection, the alkali metal salts can in each case also be alkali metal hydrogen carbonate, alkali metal hydrogen perborate and alkali metal hydrogen persulfate. However, the dialkali metal salts are preferred in each case.

Detergent compositions according to the present invention can comprise one or more bleach catalysts. Bleach catalysts can be selected from oxaziridinium-based bleach catalysts, bleach-boosting transition metal salts or transition metal complexes such as, for example, manganese-, iron-, cobalt-, ruthenium- or molybdenum-salen complexes or carbonyl complexes. Manganese, iron, cobalt, ruthenium, molybdenum, titanium, vanadium and copper complexes with nitrogen-containing tripod ligands and also cobalt-, iron-, copper- and ruthenium-amine complexes can also be used as bleach catalysts.

Detergent compositions according to the present invention can comprise one or more bleach activators, for example tetraacetyl ethylene diamine, tetraacetylmethylenediamine, tetraacetyl-glycoluril, tetraacetylhexylenediamine, acylated phenolsulfonates such as for example n-nonanoyl- or isononanoyloxybenzene sulfonates, N-methylmorpholinium-acetonitrile salts (“MMA salts”), trimethylammonium acetonitrile salts, N-acylimides such as, for example, N-nonanoylsuccinimide, 1,5-diacetyl-2,2-dioxohexahydro-1,3,5-triazine (“DADHT”) or nitrile quats (trimethylammonium acetonitrile salts).

Detergent compositions according to the present invention can comprise one or more corrosion inhibitors. In the present case, this is to be understood as including those compounds which inhibit the corrosion of metal. Examples of suitable corrosion inhibitors are triazoles, in particular benzotriazoles, bisbenzotriazoles, aminotriazoles, alkylaminotriazoles, also phenol derivatives such as, for example, hydroquinone, pyrocatechol, hydroxyhydroquinone, gallic acid, phloroglucinol or pyrogallol.

In one embodiment of the present invention, detergent compositions according to the invention comprise in total in the range from 0.1 to 1.5% by weight of corrosion inhibitor.

Detergent compositions according to the present invention can comprise one or more builders, for example sodium sulfate or sodium carbonate.

Inventive detergent compositions may be liquid or preferably solid. “Solid” in this context means solid at ambient temperature. Solid inventive detergent compositions may be powders or unit doses for laundering, for example tablet.

Solid detergent composition according to the present invention may have residual moisture in the range of 0.1 to 10% by weight, referring to their total solids content. Residual moisture is determined by dry weight determination through vaporization.

Inventive detergent compositions are very good as laundry care detergents. They exhibit good activity with respect to the removal of organic materials such as oil, blood, and food residues, even after weeks and months, for example three or more months, of storage at 20° C. or even higher temperatures, for example 35 or 37° C.

Another aspect of the present invention is the use of inventive detergent compositions for laundry care, especially for laundering textiles that are soiled with organic materials such as blood, oil and/or food residues. Another aspect of the present invention is a method of use of inventive detergent compositions for laundry care, especially for laundering textiles that are soiled with organic materials such as blood, oil and/or food residues. Such method of use includes cleaning laundry soiled with blood, oil and/or food residues, especially with blood, milk or ink, or a combination of at least two of the foregoing substances.

Another aspect of the present invention is a process for cleaning laundry and/or crockery and kitchen utensils wherein soiled laundry and/or crockery and kitchen utensils is treated with an aqueous formulation comprising at least one detergent composition according to the present invention. Preferably, soiled laundry and/or crockery and kitchen utensils is selected from laundry and/or crockery and kitchen utensils soiled with at least one substance selected from blood, milk and ink, or a combination of at least two of the foregoing substances. Such inventive process includes contacting soiled laundry and/or crockery and kitchen utensils with an aqueous liquor containing at least one inventive detergent composition. Such aqueous liquor may have a temperature in the range of from 25 to 60° C.

Even such inventive detergent compositions that have been stored over a period of weeks and months, for example three or more months, at 20° C. or even higher temperatures, for example 35 or 37° C., exhibit good laundering behaviour.

Another aspect of the present invention is a process for manufacturing at least one detergent composition according to the present invention, hereinafter also referred to as inventive process. The inventive process can be carried out by mixing, in one or more steps,
(a) at least one organic chelating agent selected from methyl glycine diacetic acid (MGDA), glutamic acid diacetic acid (GLDA), the alkali metal salts of methyl glycine diacetic acid (MGDA) and of glutamic acid diacetic acid (GLDA), and
(b) at least one enzyme selected from proteases, in the desired quantities.

Such mixing can be performed in dry state or in the presence of water. If at least one mixing step is being performed in the presence of water, and if the a solid detergent composition is to be manufactured, the water can be in whole or preferably partially removed, for example by spray-drying.

The present invention further relates to the use of detergent compositions according to the invention for automatic dishwashing meaning the machine cleaning of crockery and kitchen utensils. Within the context of the present invention, kitchen utensils to be mentioned are, for example, pots, pans, casseroles, also metallic items such as skimmers, fish slices and garlic presses. Preference is given to the use of detergent compositions according to the invention for machine cleaning of items having at least one glass surface which may be decorated or undecorated. In this connection, within the context of the present invention, a surface made of glass is to be understood as meaning that the item in question has at least one section made of glass which comes into contact with the surrounding air and may be soiled upon using the item. Thus, the items in question may be those which, like drinking glasses or glass bowls, are essentially made of glass. However, they may, for example, also be lids which have individual components made of another material, for example pot lids with edges and handle made of metal.

Surface made of glass may be decorated, for example colored or imprinted, or undecorated.

The term “glass” includes any desired glasses, for example lead glass and in particular soda-lime glass, crystal glass and borosilicate glasses.

Preferably, machine cleaning is a washing operation using a dishwasher (automatic dishwashing).

In one embodiment of the present invention, at least one detergent composition according to the invention is used for machine cleaning of drinking glasses, glass vases and glass vessels for cooking.

In one embodiment of the present invention, water with a hardness in the range from 1 to 30° German hardness, preferably 2 to 25° German hardness, is used for the cleaning, where German hardness is to be understood in particular as meaning the calcium hardness.

If detergent compositions according to the invention are used for machine cleaning, then, even upon the repeated machine cleaning of objects which have at least one surface made of glass, only a very low tendency towards glass corrosion is observed, and then only if objects which have at least one surface made of glass are cleaned together with heavily soiled cutlery or crockery. Moreover, it is significantly less harmful to use formulation according to the invention for cleaning glass together with objects made of metal, for example together with pots, pans or garlic presses.

The present invention further relates to the use of at least one organic chelating agent selected from methyl glycine diacetic acid (MGDA), glutamic acid diacetic acid (GLDA), the alkali metal salts of methyl glycine diacetic acid (MGDA) and of glutamic acid diacetic acid (GLDA) in an amount of from 4.0% to 25.0% by weight, preferably 5.0% to 15% by weight to increase protease activity in detergent compositions comprising protease. Detergent compositions can be e.g. laundry or automatic dishwashing detergent compositions.

The present invention also relates to a method of increasing protease active in detergent composition comprising the step of adding at least one organic chelating agent selected from methyl glycine diacetic acid (MGDA), glutamic acid diacetic acid (GLDA), the alkali metal salts of methyl glycine diacetic acid (MGDA) and of glutamic acid diacetic acid (GLDA) in an amount of from 4.0% to 25.0% by weight, preferably 5.0% to 15% by weight, to a detergent composition comprising protease. Detergent compositions can be e.g. laundry or automatic dishwashing detergent compositions. By the inventive use, in particular an improved fresh performance and increased storage stability are being observed.

The present invention will be further explained by examples.

### EXAMPLES

I. Automatic Dishwashing Experiments

For all experiments, pre-soiled dish monitors were purchased from the Center for Testmaterials. The soils examined were double soiled egg yolk (DM-22) and the testing was done in a dishwasher of the Whirlpool IV Gold® Series. Values for % clean are calculated by comparing results before and after washing to a perfectly clean melamine tile supplied by Center for Test-materials. ADW formulation used in the Examples:

12% Sodium carbonate

0 to 30% MGDA

3% Plurafac@ SLF-180 (a branched C10 alcohol alkoxylated obtainable by BASF)

2% Protease Excellenz™ P 1000 (obtainable by DuPont Genencor)

Measurement of % Clean
1. Calibrate the Konica Minolta reflectometer according to the manufacturer's instructions
2. Measure the “Lab” color space coordinates in 3 places on each pre-soiled dish monitor using the reflectometer.
3. Wash the panels according to one of the methods listed below.
4. After the dish monitors have dried completely, measure the “Lab” color space coordinates in 3 places on each monitor, as in step 2.
5. Calculate % clean for each point by comparing the dE value to a perfectly clean panel, according to the following equations.

dE=[(L_{(after wash)}−L_{(before wash))}²+(a_{(after wash)}−a_{(before wash))}²+(b_{(after wash)}−b_{(before wash))}²]^{1/2}

% clean=100×dE/[((93.95−L_{(before wash))}²+(−1−a_{(before wash))}²+(2.56−b_{(before wash))}²)^{1/2}

Dishwasher Test Method
1. Measure the “Lab” color space coordinates before washing the soiled dish monitors as instructed above.
2. Place one of each soiled dish monitor, evenly spaced, on both the top and bottom racks of the dishwasher. Use the stainless steel dish monitor holders to keep the monitors in place.
3. Add detergent as indicated for the experiment.
4. Select the appropriate options on the dishwasher and run one cycle.
5. Remove the dish monitors and allow them to dry completely before again measuring the “Lab” color space coordinates.

Results

TABLE 1
Results

| % MGDA | % Clean |
|---|---|
| 0 | 47.9 |
| 2 | 55.5 |
| 5.9 | 72.8 |
| 7.8 | 74.8 |
| 10 | 74.3 |
| 15 | 79.7 |
| 20 | 65.9 |
| 30 | 55.9 |

The % clean, i.e. the enzyme performance is significantly increased if MGDA is added in amounts of from 4.5 to 25%.

II. Laundry Detergent Experiments

Ingredients used

(a.1): MGDA-Na₃, 40% by weight in water

(a.2): GLDA-Na₄, 47% by weight in water

(b.1): Savinase 16L, commercially available from Novozymes

(b.2): Purafect 4000L, commercially available from Du Pont as Effectenz® P

(b.3): Purafect Prime 4000L, commercially available from Du Pont as Preferenz® P

Anionic Surfactants:

(c.1): 4-sec.-C₁₀-C₁₃-alkyl-benzensulfonic acid, sodium salt

(c.2): stripped coconut soap, potassium salt

(c.3): n-C₁₂H₂₅—O(CH₂CH₂O)₂—SO₃Na (sodium laureth sulfate)

non-ionic surfactants:

(d.1): 2:1 by weight mixture n-C₁₃H₂₇—(OCH₂CH₂)₇—OH/n-C₁₅H₃₁—(OCH₂CH₂)₇—OH

TABLE 2
Composition of base liquid detergent formulation LDF:

| Substance | g/100 g |
|---|---|
| (c.1) | 5.5 |
| (c.2) | 2.4 |
| (c.3) | 7.7 |
| KOH | 2.2 |
| (d.1) | 5.4 |
| Ethanol | 2 |
| water | To 90 g |

Manufacture of inventive laundry detergent compositions was performed by charging a flask with 90 g of base liquid detergent composition, adding enzyme (b) and (a.1) or (a.2), as the case may be, followed by subsequent addition of water to an amount of 100 g.

The following test formulations were made, see Table 3.

The test formulations were stored at 37° C. Aliquots were taken after 1, 3, 7, 10, and 14 days and the performance was measured in the launderometer at 40° C. wash temperature, test formulation dose 5 g detergent/I liquor, water hardness 14 ° dH, liqueur ratio 1:12, on stain blood/milk/ink EMPA117. Once washed, the stains were rinsed and dried. The final reflectance (L*a*b, D65 illuminant) of each swatch was determined by using a reflectometer (Elrhepho Datacolor).

TABLE 3
composition of test formulations

| | | Corresponds | (b), | Corresponds | enzyme performance |
|---|---|---|---|---|---|
| | (a), amount | to wt % (a) | amount | to wt % (b) | after 14 d [%] |
| TF.1 | (a.1), 7.5 g/100 g | 11.5 | (b.1) | 0.3 | 88 |
| TF.2 | (a.1), 6 g/100 g | 9.4 | (b.1) | 0.3 | 81 |
| TF.3 | (a.1), 4.5 g/100 g | 7.2 | (b.1) | 0.3 | 77 |
| TF.4 | (a.1), 3 g/100 g | 4.9 | (b.1) | 0.3 | 77 |
| C-TF.5 | (a.1), 1.5 g/100 g | 2.9 | (b.1) | 0.3 | 72 |
| C-TF.6 | — | — | (b.1) | 0.3 | 79 |
| TF.7 | (a.1), 7.5 g/100 g | 11.5 | (b.2) | 0.3 | 86 |
| TF.8 | (a.1), 6 g/100 g | 9.4 | (b.2) | 0.3 | 83 |
| TF.9 | (a.1), 4.5 g/100 g | 7.2 | (b.2) | 0.3 | 76 |
| TF.10 | (a.1), 3 g/100 g | 4.9 | (b.2) | 0.3 | 74 |
| C-TF.11 | (a.1), 1.5 g/100 g | 2.9 | (b.2) | 0.3 | 69 |
| C-TF.12 | — | — | (b.2) | 0.3 | 74 |
| TF.13 | (a.1), 7.5 g/100 g | 11.5 | (b.3) | 0.4 | 96 |
| TF.14 | (a.1), 6 g/100 g | 9.4 | (b.3) | 0.4 | 91 |
| TF.15 | (a.1), 4.5 g/100 g | 7.2 | (b.3) | 0.4 | 79 |
| TF.16 | (a.1), 3 g/100 g | 4.9 | (b.3) | 0.4 | 70 |
| C-TF.17 | (a.1), 1.5 g/100 g | 2.9 | (b.3) | 0.4 | 63 |
| C-TF.18 | — | — | (b.3) | 0.4 | n.d. |

Amounts in Table 3 are tel quell.

Wt % (a) and wt % (b) refer to the solids content

The enzyme performance after 14 d is expressed in % of initial performance

With (a.2), a similar trend could be observed.

If the enzyme activity drops to less than 70% within 14 days the wash results are usually deemed commercially inacceptable.

1-13. (canceled)

14. Process for manufacturing at least one detergent composition comprising protease having at least one of increased protease activity and storage stability, the process comprising mixing, in one or more steps,
(a) in total in the range of from 4.0% to 25.0% by weight of at least one organic chelating agent selected from the group consisting of methyl glycine diacetic acid (MGDA), glutamic acid diacetic acid (GLDA), the alkali metal salts of methyl glycine diacetic acid (MGDA) and of glutamic acid diacetic acid (GLDA), referring to the total solids content of the respective detergent composition, and
(b) at least one enzyme selected from proteases.

15. (canceled)

16. A method of increasing at least one of protease activity and storage stability of protease in detergent compositions, the method comprising adding at least one organic chelating agent selected from the group consisting of methyl glycine diacetic acid (MGDA), glutamic acid diacetic acid (GLDA), the alkali metal salts of methyl glycine diacetic acid (MGDA) and of glutamic acid diacetic acid (GLDA) in an amount of from 4.0% to 25.0% by weight to a detergent composition comprising protease.

17. The method of claim 16, wherein the detergent composition is at least one of a laundry detergent composition and an automatic dishwashing detergent composition.

18. The method of claim 16, wherein the at least one organic chelating agent is added in an amount of from 5.0% to 15% by weight to the detergent compositions comprising protease.
